(19) United States
(12) Patent Application Publication
(10) Pub. No.: US 2002/0089537 A1
(43) Pub. Date: Jul. 11, 2002

(54) System and method for threading heterogenous communications in collaborative process contexts

(76) Inventor: Vasant Balasubramanian, Santa Clara, CA (US)

Correspondence Address: GLENN PATENT GROUP, 3475 EDISON WAY, SUITE L, MENLO PARK, CA, 94025, US

(21) Appl. No.: 10/032,110

(22) Filed: Dec. 19, 2001

Related U.S. Application Data
(60) Provisional application No. 60/258,032, filed on Dec. 22, 2000.
(60) Provisional application No. 60/258,033, filed on Dec. 22, 2000.

(51) Int. Cl. G09G 5/00; G06F 15/16

(52) U.S. Cl. 345/751; 345/758; 345/709; 709/203

(57) ABSTRACT

A system and method for threading heterogeneous communications in collaborative contexts organizes diverse communication items in their own diverse formats into communication threads resembling those of discussion groups. The invention allows participants to create and/or post items (e.g. chat rooms or documents) and respond to posts with related items (e.g. relevant files or comments). Additionally, a method and system for associating these communications threads with individual steps in a business or design/development process is provided. A common user interface allows use of a variety of communication mechanisms such as chat rooms, electronic whiteboards, notes and documents. A threading server maintains a complete list of items in all threads, along with the process steps that refer to each communication item. For each communication item, the server also maintains an index explicitly identifying each item in its native system, so that access to disparate systems is enabled without replicating functionality or data.

### CROSS REFERENCE TO RELATED APPLICATIONS

This application claims benefit of U.S. Provisional Patent Applications Serial Nos. 60/258,032 and 60/258,033, both filed on Dec. 22, 2000.

### BACKGROUND OF THE INVENTION

1. Field of the Invention

In general, the invention is directed to the field of computer-based collaboration. In particular, the invention is directed toward a system and method for threading together of a heterogeneous set of communications in a post-and-response manner to create persistent threads of communication and associating them with steps in a process.

2. Description of Prior Art

Present systems that model business (or development) processes usually provide a mechanism to make notes or associate one or more files with any specific process step and then share them with other participants in the process. However, these ‘attachments’ to process steps are usually just a simple list of items and are restricted to a finite set of communication types (notes and files). These communications carry no more context with respect to each other than their association with the same process step.

There are three distinct categories of collaborative communication mechanisms in widespread use today:

Newsgroups or electronic discussion systems allow participants to post new topics and then allow other users to respond to the posts. Participants may also respond to other user's responses. Hence, users can have threaded discussions with posts, responses, and responses to responses. FIG. 1 shows a typical interplay of post and response in such an environment. However, newsgroups or discussion groups are generally limited to exchange of textual messages (including possibly images, audio and video). Typically a discussion group server may host one or more such forums or discussions.

For example, A. Pizano, W. Su, M. Yan, L. Pham, Method and apparatus for asynchronous multimedia collaboration, U.S. Pat. No. 6,105,055 (Aug. 15, 2000) describe a system for asynchronous collaboration that allows a form of conferencing in which users may post and annotate multimedia presentations. The presentations, organized into threads, are accessed through a conventional web browser. While the described system considerably expands the capabilities of a conventional newsgroup, it is constrained to the exchange of one communication type, albeit one providing multimedia capability, the multimedia presentation itself. No capability is provided of posting and responding to a variety of communication types. Furthermore, there is no capability of associating posts and responses with the steps of a process.

On the other hand, standalone communication mechanisms such as chat rooms (e.g. Yahoo! Chat, ICQ) and electronic virtual conferences (e.g. Microsoft NetMeeting, WebEx) allow users to communicate in real time on any topic of their choosing. Typically, one or more servers may serve multiple ‘channels’ of chat rooms (or meetings) and users can sign on to any topic of interest. Alternatively, users can also set up private chat rooms or meetings and restrict access to a select set of users. As with newsgroups, the range of usable communication types is limited, and while devoting a chat to a particular topic provides some context, it is coarse and top-level in nature. No facility is provided for threading a chat into a collaborative thread along with other communication types or associating the thread with a process or individual process stops.

Finally, a third form of communication is document sharing, wherein documents (files) are uploaded to a common area or server and other authorized users can view, edit or download the files. Typically, these systems do not place limits on the types of files that can be placed in the file store (e.g. iShare). Document management systems are another form of file sharing where documents may be versioned or annotated by different users (e.g. Synchronicity, ClearCase).

For example, W. Adams, Framework for constructing shared documents that can be collaboratively accessed by multiple users, U.S. Pat. No. 5,781,732 (Jul. 14, 1998) provides a system whereby multiple users can simultaneously access and manipulate a shared document in an interactive and real-time manner.

Y. Watanabe, S. lino, Y. Morita, K. Nishimori, I. Kijima, Method, apparatus, system and program storage device for distributing intellectual property, U.S. Pat. No. 6,157,947 (Dec. 5, 2000) describes a system for the distribution of intellectual property to be reused for semiconductor product designing. Neither of these systems provides the capability of associating heterogeneous communications in a thread, or associating the threaded communications with steps of a business process.

In the context of a business or product design/development process, communications can take many forms and can have a complex interplay of post and response, containing different types of communications mechanisms such as real-time chats, post-it notes, emails, and electronic documents. Additionally, the types of communications and their nature can vary depending on the process step or phase.

However, current systems only allow either discrete communications (chat rooms, etc) or threaded electronic discussion boards containing only text or some multimedia without addressing the need to work all into a coherent and cohesive whole.

Additionally, teams operating within the scope of a process (business, design, development, etc) usually communicate in the context of an individual step or phase of the process and present systems provide a very restricted range of capabilities for dealing with such process-oriented intra-team communication scenarios.

### SUMMARY OF THE INVENTION

In recognition of the aforementioned needs, the present invention provides a system and method for threading heterogeneous communications in collaborative contexts.

In one embodiment, the invention provides a general method for threading a diverse set of communication mechanisms into a form that provides persistence and context to each communication item. To this end, the invention provides the capability of linking a heterogeneous set of electronic communications into a post-response metaphor to create a threaded trail of collaborative communication. Additionally, the invention also provides the capability of creating ‘placeholders’ for communication items without actually associating data with the item till a later time. Another embodiment of the invention provides a method for associating different steps within a process with one or more threads of communication.

In a further embodiment, the invention provides a system and architecture for implementing such heterogeneous threaded communications by means of a threading server that maintains information about each post and response and the process step that the communication items are associated with. In addition, the server maintains information about how to access the actual data pertaining to each communication item without actually storing the data or duplicating the core functionality of the communication mechanism.

In a still further embodiment, the invention provides an open interface that supports the creation of ‘connectors’ to hook up any external communication mechanism (chat rooms, document store, etc) with the threading server. In this way, a user may create a new post or respond to existing posts using any of the various collaborative mechanisms registered with the threading server. Users can also view existing posts or responses of any type from a single interface that displays all the communication threads.

And finally, the invention is embodied as a user interface for displaying the threads of communication. The user interface includes the capability of creating new posts or responding to existing posts from the client. The user interface can also be invoked by selecting a process step and viewing associated communication threads, either from an external viewer or an application that displays a model of the process.

### BRIEF DESCRIPTION OF THE DRAWINGS

FIG. 1 provides a diagram depicting typical post and response relationships in a communication thread;

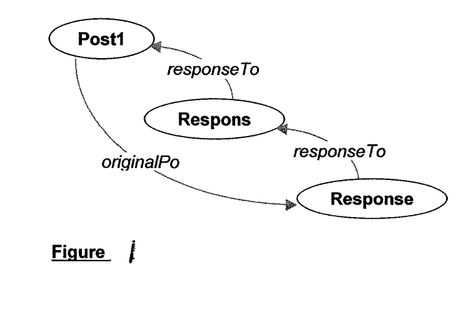

FIG. 2 provides a diagram of a business post and response scenario according to the invention;

FIG. 3 provides a block diagram of a system for threading heterogeneous communications in collaborative contexts according to the invention;

FIG. 4 provides a diagram of an open interface to heterogeneous communication mechanisms from the system of FIG. 3 according to the invention; and

FIG. 5 shows a user interface from the system of FIG. 3 wherein communication threads are associated with a step in a business process according to the invention; and

FIG. 6 shows the results of a search performed to retrieve all communications that are associated with a step in a business process according to the invention.

### DETAILED DESCRIPTION

Different types of basic communication mechanisms exist today. These include chat rooms, notes, electronic drawing boards, document sharing etc. Additionally, different corporations may have additional proprietary collaboration systems such as meeting servers and bug tracking systems.

Usually, these systems exist as separate entities, with no correlation between different individual communication items. For example, after emailing several questions and answers back and forth between team members concerning some problem, a team may create a chat room to discuss the matter in real time. They may then follow this up with a bug submitted to their bug database. In a similar scenario, a design architect posts a new functional specification document and makes a request for comments from the members of a group. This may then be followed up with a meeting to discuss the document.

However, the different forms of communications employed (notes, chat rooms, document sharing, etc) all exist either in disparate systems with no linkage from, for example, the original problem specification note to the chat room that talked about it to the bug that was filed about it.

Such scenarios are very common in the business arena.

One embodiment of the invention provides a common unifying metaphor for linking (threading) all these disparate communication items for the same topic as posts and responses.

In its simplest form, the system resembles an electronic discussion group in which users post notes to a common discussion (hosted on some discussion server) with other users responding to the posts. Some discussion group systems may also allow the posts to contain attached files. Subsequently, other users may respond to the posted response, or to a previous response. In this manner, the participants create a ‘thread’ of communication comprising a heterogeneous set of registered communication item types.

As previously indicated, the invention accommodates the broad variety of communication mechanisms available within a corporation by not imposing any constraints relating to the type of communication mechanism used for each post and response. The only restriction imposed by the system is that users employ any of a selection of available registered communication types (including chat rooms, bugs, documents, etc). Thus, the system has the capability of focusing on threading diverse communications while imposing few or no constraints on the type of communication threaded. To achieve this goal, the system incorporates an open and flexible architecture that supports any registered communication type (chat room, note, shared docs, bugs, etc), providing a well-defined interface that integrates all communication types.

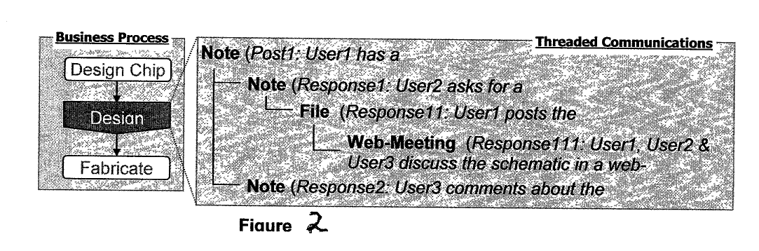

FIG. 2 shows a diagram applying this model to an exemplary business scenario. User1 first posts a ‘Note’ about a problem. Then User2 responds to this note with some comments (Note) and asking for a schematic drawing showing where the problem occurred (File). User1 then uploads the schematic drawing file requested by User2—as a response to User2's response. At this time, User3 may join the discussion and respond to User1's original post with another question or comment in the form of a ‘Note’. Next, all users may get together on an electronic whiteboard to discuss the schematic.

In this manner, all communications (chat rooms, notes, bugs, etc) are created in-context, providing a complete tracking record of what items preceded and what items followed each individual item within a particular thread.

Additionally, the system provides the capability for posts (or responses) to be created as ‘placeholders’ lacking any actual data at the time of creation. For example, a newly created document may need to be accompanied by a justification document created by someone other than the creator of the original document, and several approvals by yet others. In anticipation of such need, the original document creator can first post the original document. Then he or she will create response placeholders for the requisite number of approvals and justifications without including any actual data. Subsequently, the original document creator may assign these response placeholders to the parties who are supposed to fill in the placeholder with actual data.

In one or more other embodiments of the invention, the heterogeneous threaded communications introduced above are linked with their respective processes, such processes comprising any of business, product design and development processes that may be in progress within an organization or company. Specifically, the invention provides a method and system for associating one or more communication threads with either a process or with an individual step of a process, providing important additional information about each thread of communication by placing it within the context of its associated process or process step.

### SYSTEM OVERVIEW AND USE MODEL

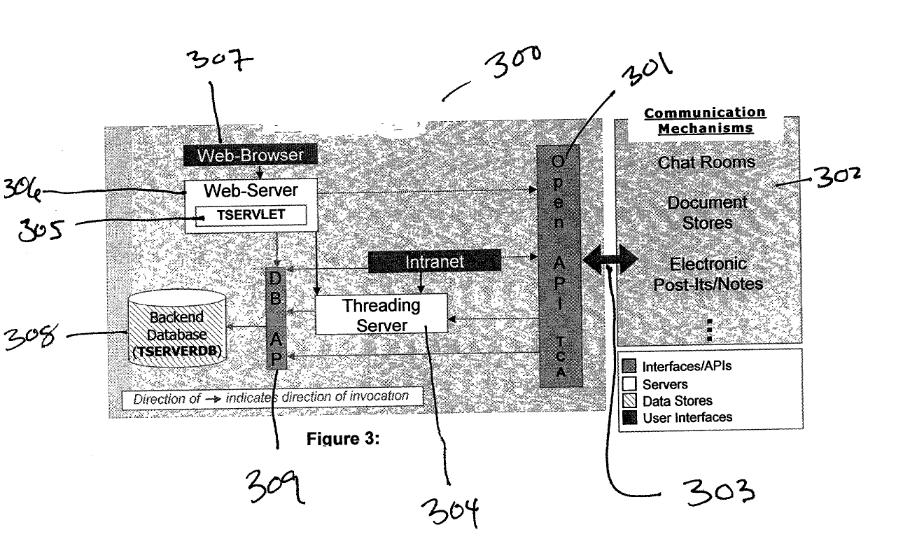

Referring now to FIG. 3, a diagram of a system according to the invention is provided. The several components of the system and their interrelationships are described within the context of a variety of exemplary user interactions.

The system 300 includes:

An open interface (Threading Connector API-TCAPI) for defining connectors to different external communication systems 302;

Actual connectors 303 that link the invented system to each external communication system for example, a chat room system connector, a document sharing system connector, and so on. The connectors are created based on the open interface and the communication system that they are connecting to;

A Threading Server 304, where connectors are registered and new communication entries are created. The threading server also functions to make the associations between process steps and communication threads. (Threading Server-TSERVER);

A Threading Server Java servlet component 305 that is instantiated within a web server 306 and forms the link between an external web browser 307 and the threading server 304. (Threading Servlet-TSERVLET);

A backend database 308 where the threading server stores information about each communication item. (Threading Server Backend Database-TSERVERDB);

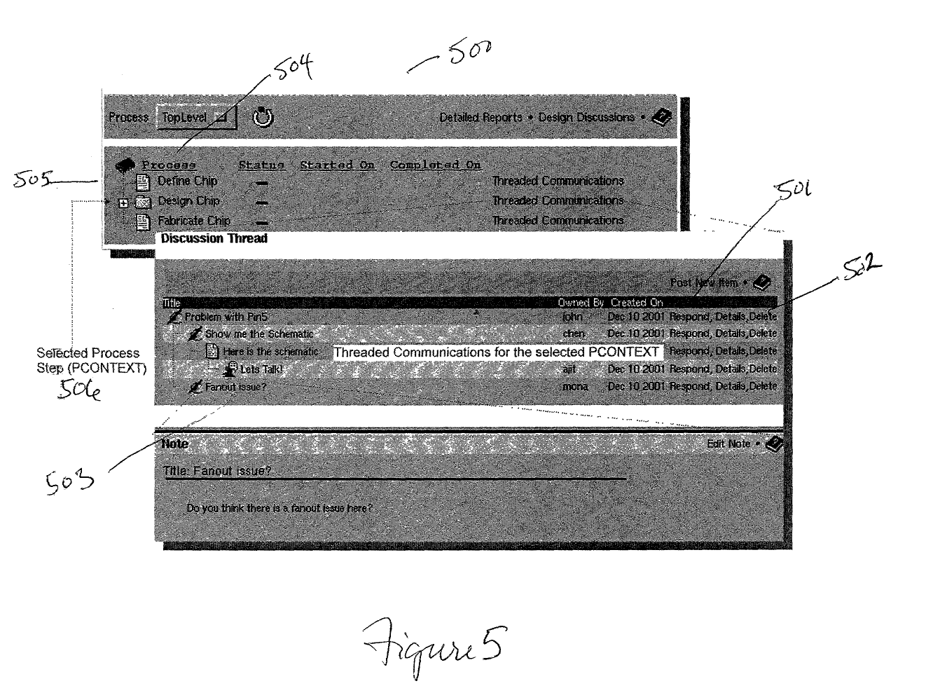

A user interface, shown in FIG. 5, for interacting with the system. The user interface may be used from either the web browser 307 or an intranet java-based application; and

An external process definition database or system (not shown) maintains process information. Within the framework of the invention, however, a ‘context specification’ (PCONTEXT) 506 includes a process ID and process step ID. Thus, every step in every process 505 is uniquely identified by a process ID and process step ID that together constitute a process context 506.

Described below are a variety of exemplary user interactions that illustrate data and control flows within the system.

POSTING A DOCUMENT (FROM WITHIN WEB BROWSER 307)

User activates a ‘Post New Item’ interface element;

This sends a request to the TSERVLET 305, which retrieves the registered list of communication types from the TSERVER 304 and then presents them to the user as a list;

The user selects ‘SharedDocument’ from the list and this request is sent to the TSERVLET 305;

The TSERVLET 305 notes that the user has asked to create a new post of type ‘SharedDocument’. It loads the web-connector 303 for the ‘SharedDocument’ communication type;

The TSERVLET 305 then indicates to the SharedDocument web-connector 303 that a new post is to be created;

The SharedDocument web-connector 303 then redirects the user to another web page where the user may specify the file to be uploaded, along with various details related to the file. The skilled practitioner will note that this web page and the interactions therein originate from within the ‘SharedDocument’ communication system 302, external to the invented system 300;

Using, for example, a ‘Browse’ feature, the user supplies the path and file name of the file to be uploaded. Subsequently, the file is uploaded to the SharedDocument system 302, which first validates the user input and creates an entry for the uploaded file in its own backend system;

Through the TCAPI 301, the SharedDocument System informs the threading server 304 that a new communication of the SharedDocument type was created that includes the uploaded file, providing a title, description and a tag that can later be used to identify the newly uploaded document; and

The TSERVER 304 takes this information and creates an entry in the TSERVERD 308 for the new post.

Thus, the user has now posted a new document that is stored in the SharedDocument system's native backend database and an entry describing it has also been registered with the threading server 304.

The foregoing description of posting a new document serves to illustrate a more general process of posting new items. As described elsewhere, items of varying type may be posted. One scenario offering particular utility involves posting of bug reports. Users can post bug reports to the thread, provided that the bug database has previously been registered as one of the post types. Thereafter, the bug database would then be brought into the thread upon invocation by a user.

VIEWING ALL POSTS AND RESPONSES (FROM WITHIN WEB BROWSER 307)

User activates a ‘View all posts and responses’ interface element within the web browser 307;

This request is sent to the TSERVLET 304 which queries the TSERVERDB 308 for all posts and responses, starting with the most recently created items first. The skilled practitioner will appreciate that, since the TSERVERDB contains all the titles and descriptions for each item, it can directly retrieve information about each type of communication from a single database table; and

This information is sent back to the web browser screen as a browseable list.

POSTING A RESPONSE COMMENT (FROM WITHIN WEB BROWSER 307)

User clicks on a ‘View all posts and responses’ interface element in the web browser 307, as described above;

This brings up a screen with all posts and responses as in a simple search. Each line also includes a link named ‘Respond’ 501;

User clicks on the ‘Respond’ link 501 to the desired post; and

From this point, the flow of control is exactly the same as in the above-described procedure for posting a Document; with the exception that the ‘Note/Comment’ system connector is activated, rather than that for the SharedDocument system. Also, the ID of the communication item to which this is a response is passed to the connector 303. This additional information is then used by the connector when registering the new item's information with the TSERVER 304.

DELETING A COMMUNICATION ITEM (FROM WITHIN WEB BROWSER 307)

User views all posts and responses, as previously described;

This brings up a screen with all posts and responses as in a simple search. Each line also includes a link named ‘Delete’ 502;

User clicks on ‘Delete’ 502 for the desired item;

This sends the deletion request to the TSERVLET 305 for this item ID;

The TSERVLET 305 determines the type of this item and calls the deletion function in the appropriate web connector for this item type; and

If the web connector returns a ‘success’ status, then this entry is also removed from the TSERVERDB.

OPENING/VIEWING A POST OR RESPONSE SHARED DOCUMENT (FROM WITHIN A WEB BROWSER)

User clicks on ‘View all posts and responses’ in a web browser;

This brings up a screen with all posts and responses as in a simple search;

User clicks on the title 503 for the item to open;

This sends an ‘open’ request back to the TSERVLET 305 for the item associated with this item ID;

The TSERVLET 305 determines the item type (SharedDocument) and loads the web connector for this communication type;

The TSERVLET 305 then calls an ‘open’ function on the web connector and passes the additional tag that was stored with this item when the SharedDocument system's servlet first created this entry in the TSERVER; and

The SharedDocument web connector forms the appropriate URL for opening this document and redirects the web browser to that URL.

WORKING WITHIN THE CONTEXT OF A PROCESS STEP: All the interactions described previously can also be performed within the context of a process step.

In this case, the first screen or window 504 contains a depiction of the process 505 (from a process definition database);

The user then selects a specific process step (PCONTEXT) 506 and chooses to view all threaded communications for that step;

This results in a query to the TSERVERDB 308 (through the TSERVLET 305 or directly through the DB API 309) for a list of all communications associated with the selected PCONTEXT 506; and

This list of threaded communications is then presented to the user in a new window or screen.

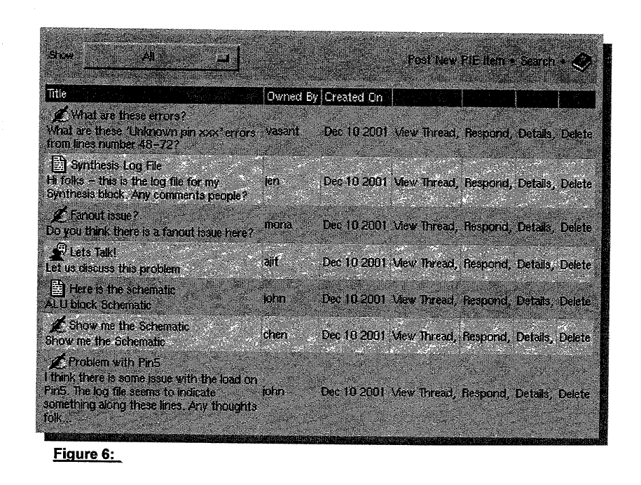

Thus, a basis is provided for accessing threaded communications within the context of a process step 506. Accordingly, any new posts, responses or other interactions (as described above) from this window are also tagged with the PCONTEXT 506 and passed on to the TSERVER 304 when new posts or responses are registered, as previously described. FIG. 6 shows the results of a search performed to retrieve all communications that are associated with a step in a business process. In this manner, one can see how the various components and interactions depicted in FIG. 3 come to life. In the following sections, detailed functional descriptions of the various components of the invented system are described.

As indicated above, the invention operates in concert with an external process definition database or system, which supplies process information. The invention is linked with the external process definition application such that a collaborative thread associated with a particular process or step of a process may be viewed and accessed from within the external application. For example, in a process definition application wherein a process and its various steps are represented graphically, selection of the graphical element representing a particular process step invokes the invention so that any thread associated with that process step is displayed to the user. Subsequently, the user may view the various communications comprising the thread, and submit new posts to the thread.

### INTEGRATING COMMUNICATION TYPES USING THE TCAPI

(threading connector API) 301

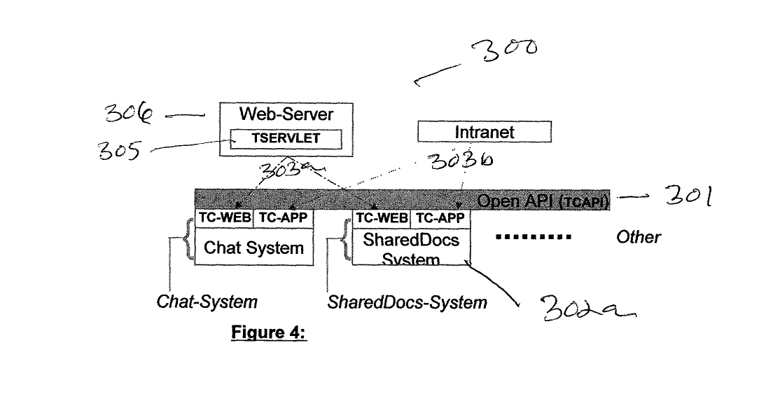

Fundamental to deploying the invented system is the building of ‘connectors’ that form a bridge between the system and the native system of the communication type, as shown in FIG. 4.

For example, to integrate a document sharing system 302a with the invention, a connector must be created that accepts different requests from the invented system 300 and then performs the appropriate task in the document sharing system 302a.

The invention's open interface (TCAPI) 301 requires each integration of a communication type to define two connectors—one for embedding within a web server (TC-WEB) 303a and another for embedding within an application working over an intranet (TC-APP) 303b.

The web connector 303a, from the web server, operates to handle requests for creating new items or for opening existing items. The web connector is always instantiated and used from within the TSERVLET 305. The web connector defines the following methods:

Create a new item of this type (createCommunicationItem). If this item is a response to another posted communication item, then this method will also be provided with the ID of the original post;

Delete an existing item of this type (deleteCommunicationItem);

View an item of this type (viewCommunicationItem);

Edit an item of this type (editCommunicationItem); and

Indicate whether this communication item supports ‘delayed creation’. Delayed creation allows the threading server to create an entry for new items of this type in the threading server's database without actually creating the corresponding item in the communication item's data store. In this manner, new communication items can be created as placeholders that are later filled in, as previously described.

The intranet 303b client connector serves the same purpose as the web connector 303b, but is used from within an intranet client. The intranet connector defines the following methods:

Create a new item of this type (createCommunicationItem). If this item is a response to another posted communication item, then this method will also be provided with the ID of the parent item;

Delete an existing item of this type (deleteCommunicationItem);

View an item of this type (viewCommunicationItem);

Edit an item of this type (editCommunicationItem); and

Indicate whether this communication item supports ‘delayed creation’.

While the methods of the intranet connector 303b and the web connector 303a are analogous, due to their differing modes of use (within a graphical internet client vs. within a web server) they each have different parameters.

THREADING SERVER (TSERVER) 304

At the core of the invented system is the Threading Server 304. This server forms the conduit for creating new communication items in the backend data store 308. This server also stores a list of all registered communication types available and for which connectors 303a, b (using the open interface) have been defined.

Registering Communication Types—As described previously, to integrate a communication type with the system, it must be registered. Registration involves providing the following types of information concerning the communication type:

Name—displayed in the use list of registered communication types, e.g. DocumentShare;

Short description—provides additional details about a communication type in the system's user interface;

Sample: This is a place where you can store and access shared documents

The Java class that implements the web connector for this communication type. This information is used by the threading server to support requests generated through a web-browser for:

creating new communications,

opening existing communications,

deleting communications, and so on;

Sample:

com.mycompany.docshare.DocumentShareWebConnec tor

An image file that can be used to show items of this type within a web browser;

Sample: webdocshare.gif

The Java class that implements the intranet client connector for this communication type. This information is used by the threading server to support requests generated through intranet client for:

creating new communications,

opening existing communications,

deleting communications, and so on;

Sample:

com.mycompany.docshare.DocumentShareClientConnecto

r

An image file that can be used to show items of this type within the intranet client;

Sample: iclientdocshare.gif

And, optionally, the name of the web server host where this communication mechanism's server is running. This information is used by the web and intranet client connectors to locate the computer currently running the basic communication system of this type;

Sample: docsharehost:8080

Once this information is made available to the TSERVER 304, clients (including the TSERVLET 305 and other intranet applications) can query the TSERVER for the different types of communication mechanisms and details on how to use them (using the Threading Connectors 303a,b).

### STORED DATA TYPES

Two main types of data are created and retrieved as users interact with the system: the communications items that are created, and the PCONTEXT's 506 that refer to a given communication item.

COMMUNICATION ITEMS

As users create posts and responses, the TSERVER 304 creates a unique ID for each new item and stores it into a table within its backend database system 308 with the following attributes:

ID: This is a unique ID for this communication item;

Title: This is the title for this communication item;

Description: This is a short description about this communication item;

Type: This is the type of communication item. This type must have been previously registered with the threading server;

Original Post ID: This is the ID of the original post that started the whole thread (may be undefined if this item itself is the original post);

Response To ID: This is the ID of the item to which this item is a response (may be undefined if this item itself is the original post); and

Item Data: This is a marker or some string that is passed to the appropriate communication item type to open/view/delete this communication.

PROCESS CONTEXT (PCONTEXT) FOR COMMUNICATION ITEMS

As users create new posts and responses within the context of a process step, the TSERVER 304 is also passed the PCONTEXT 506 for the new item. After creating the entry for the communication item itself, the TSERVER then creates a new record of information in a second table tagging the specified PCONTEXT and the new item's ID together as a pair. The data store can then be queried at a later time for all IDs that pertain to a specified PCONTEXT. The skilled practitioner will also appreciate that absence of a PCONTEXT-Communication Item ID pair is also possible. In this case, the communication item exists in the database without any additional context information.

### THREADING SERVER BACKEND DATABASE (TSERVERDB) 308

As each new item of communication is created, the TSERVER 304 needs a persistent data store to keep this information. While various means for storing this data are suitable for the invention, such as custom formatted files on a simple file system, or object-oriented databases, preferred embodiments of the invention utilize relational databases. Relational databases are particularly well suited for the invention because:

They easily store the ‘record/row’ of information about each communication item (item details and context information); and

There are a number of commercially available relational database applications, such as ORACLE and SYBASE, which possess the required capability of serving large numbers of simultaneous accesses.

All accesses to the TSERVERDB 308 are mediated through a standard API (TSERVERDB-API) 309 to shield all parts of the application from unexpected problems relating to the database application.

All query functions (to retrieve threaded communication items) are directly routed through this TSERVERDB-API 309 to the TSERVERDB 308 instead of going through the TSERVER 304, thereby easing the load on the TSERVER.

### USER INTERFACE

The following types of interactions are defined for users of the invention:

Creating a new Post of any communication type;

Viewing a list of all posts and responses in reverse order of creation;

Searching through all posts and responses according to user-defined criteria;

Viewing a list of all responses to a given post as a post-response tree;

Opening/Viewing a post/response item;

Creating a new response for any given post or response;

Deleting a post/response item; and

Viewing details about a post/response item.

Additionally, these same interactions are also provided within the scope of a specific PCONTEXT 506—if they were first accessed from a specific PCONTEXT. In other words, all the interactions defined in this section can have a preceding step where the user accesses the process, selects a step (PCONTEXT) and then views all threaded communications within that scope. The user having performed such operation, all subsequent operations occur in the scope of the selected PCONTEXT.

Moreover, it should be noted that the user interface is defined for use within a web-browser client (over the internet or intranet) or within a standalone application (over the internet).

CREATING A NEW POST

The first step in seeding the system with data is to create a new post.

The user clicks on a button or link that says ‘New Post’;

This launches a form or window listing all the available types of communication items that can be posted along with a little icon for the type. This list is the actual list of communication types registered with the TSERVER.

The user selects the desired type of communication to post and is taken to the next form or window that contains all the fill-in fields required for the desired communication type. For instance, a SharedDocument communication item may require a file to be uploaded, whereas a Note communication item may require just a title and note contents.

The user now clicks on. ‘Create’ or ‘Submit’ in the form or window to create the new communication.

Note: If this operation is performed within the scope of a PCONTEXT, then this will create the post within the scope of that PCONTEXT.

VIEWING A LIST OF ALL POSTS AND RESPONSES IN ORDER OF CREATION

Especially advantageous is the capability of viewing posts and responses in reverse chronological order so that users can quickly see which entries were most recently created:

The user clicks on a button or is directly taken to a page that lists the latest ten or twenty, etc communication items that were created, in which the list contains both posts and responses;

For each post or response in the list, the user can:

Open/View it;

View the complete post/response hierarchy as a tree;

Respond to it;

Delete it; or

View details about it.

Note: If this operation is performed within the scope of a PCONTEXT, then the list will only display threaded communications associated with that particular PCONTEXT.

SEARCHING THROUGH ALL POSTS AND RESPONSES ACCORDING TO USER-DEFINED CRITERIA

The invention provides the capability of searching posts and responses according to any of the following criteria:

Communication Type (Chat Rooms, Shared Documents, etc);

Keyword (title, description, partial or complete match);

Creator;

Creation Time (Created after);

Posts only OR Posts and Responses.

The user fills in all the requisite search options and clicks on ‘OK’ or ‘Search’

This leads the user to a listing of all items that matched the search criteria.

Note: If this operation is performed within the scope of a PCONTEXT, then this will only list all threaded communications within that PCONTEXT.

VIEWING A LIST OF ALL RESPONSES TO A GIVEN POST AS A POST-RESPONSE TREE

In keeping with one of the primary objects of the invention of linking disparate communication items in a post-response trail, the user interface provides the capability, as shown in FIG. 5, of viewing the threads in collapsible hierarchies.

From a listing obtained as previously described, the user chooses to ‘View Thread’ for a particular item;

This leads the user to a form or window with a hierarchical tree listing. The tree's root is the original post and all sub-nodes in the tree indicate the responses to the original post and responses to previous responses.

For each post or response in the tree, the user can

Open/View it;

Respond to it;

Delete it; and

View details about it.

OPENING/VIEWING A POST/RESPONSE ITEM

The user interface provides a simple means of opening/viewing a communication item:

From a listing obtained as previously described, the user clicks on the post/response to view; and

This performs the open action on the item—as is appropriate for that item. For example, opening a chat room would open a new window with a chat room in it. Opening a communication item that is a file would open the file in the appropriate type of file viewer. And opening a note type of communication item would open a window showing the contents of the note.

CREATING A NEW RESPONSE FOR ANY GIVEN POST OR RESPONSE

After a post is created, other users must also be able to respond to the original post with another communication item.

The user first views a listing of posts and responses as previously described;

From this listing, the user then chooses to respond to some item;

This launches a form or window listing details of the original post and all the available types of communication items that can be used for a response along with a miniaturized icon indicating the communication type. This list is the actual list of communication types registered with the TSERVER;

The user selects the desired type of communication to respond with and is taken to the next form or window that contains all the fill-in fields required for the desired communication type. For example, a SharedDocument communication item may require a file to be uploaded, whereas a Note communication item may require just a title and note contents;

The user now clicks on ‘Create’ or ‘Submit’ in the form or window to create the new communication as a response;

Note: If this operation is performed within the scope of a PCONTEXT, then this will create the response within the scope of that PCONTEXT.

DELETING A POST/RESPONSE ITEM

Deleting a post will not delete the responses, and a post or response can only be deleted by the creator or by a system administrator.

VIEWING DETAILS ABOUT A POST/RESPONSE ITEM

The system provides the capability of viewing additional details about each communication item that is not usually important at a first level of detail:

The user chooses to ‘View Details’ for some item;

This opens a new window with the following information:

Title;

Description;

Type;

Creator; and

Time of creation.

### SYSTEM ARCHITECTURE CONSIDERATIONS

CONNECTING TO A HETEROGENEOUS SET OF COMMUNICATION TYPES WITH TCAPI

Because the invention requires an open and extensible set of communication types, it is imperative that the invention's core architecture be cleanly separated from the inner workings of the various registered external communication systems. Furthermore, it is also important to provide a clean interface for external systems to access all relevant portions of the threading database. Accordingly, the invention defines its own complete and correct application-programming interface (API) to properly connect to external communication systems.

USING A COMMERCIAL RELATIONAL DATABASE (RDBMS) FOR THE TSERVERDB

As mentioned previously, commercially available relational database applications provide the best option for storing data related to each individual communication item created due to the following advantages:

They are a natural fit to store the ‘record/row’ of information about each communication item; and

A typical application of the invention needs to serve large numbers of simultaneous accesses. Hence, commercially available database systems such as ORACLE and SYBASE are ideal for this purpose.

DATA STORAGE

It is important to limit data stored in backend data store to the most relevant pieces of information. One skilled in the art will appreciate that the TSERVERDB cannot make any assumptions about the type of data storage requirements for each communication type.

ID, Title, Creator, Creation Time & Description, consolidated into one table for easy searching and access are obvious choices of data types to be included in the backend data store. The actual data for each item remains in the communication type's own data store.

An item record further includes pieces of information for maintaining threading information; specifically, a field detailing a communication item to which this communication item is a response.

Additionally, in anticipation of frequent queries for an entire thread of information, an additional field identifying the Original Post ID is provided to tag all communication items from the same thread.

SPLITTING PCONTEXT INFORMATION FROM COMMUNICATION ITEM INFORMATION

Information about each communication item is kept separate from any PCONTEXT information so as to allow multiple PCONTEXT's to map to the same communication item. In other words, PCONTEXT's are associated with each communication item record by means of a separate table, rather than including the PCONTEXT in the actual record, thus allowing the creation of mappings from multiple PCONTEXT's to the same communication item ID.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A system for threading heterogeneous items of electronic communication into a post-response metaphor, comprising:
means for interfacing with a plurality of external communication systems of varying type; and
a server, said server operative to create records that uniquely identify and link communication items created by a plurality of users within any of said external communication systems whereby a threaded trail of collaborative communication is created.

2. The system of claim 1, wherein said means for interfacing with said external communication systems comprises a threading connector API (application programming interface), said threading connector API operative to build connectors to said external communication systems.

3. The system of claim 2, wherein said connectors define methods for interacting with said external communication systems.

4. The system of claim 2, wherein said methods include:
creating a new item;
deleting an existing item;
viewing an item;
editing an item; and
creating a placeholder for a future item.

5. The system of claim 2, wherein a connector accepts a request for an action from within said system and initiates said requested action in one of said external systems.

6. The system of claim 2, said server comprising a threading server, said record including:
a unique ID;
title;
description;
type;
original post ID;
parent ID; and
item data.

7. The system of claim 6, wherein item data comprises a marker or string passed to a native external system for the purpose of interacting with the item.

8. The system of claim 7, wherein said items of communication are stored within the external system from which they originate.

9. The system of claim 6, wherein said connectors are registered on said threading server.

10. The system of claim 9, wherein registering a connector comprises providing:
name of a communication type to be registered;
a description of said type to be registered;
at least one class that implements said connector of said type to be registered through a client;
at least one image file to designate items of said type to be registered within a user interface of said client; and
optionally, network address of a server for said type to be registered.

11. The system of claim 9, wherein said threading server provides a listing of registered communication types.

12. The system of claim 2, further comprising a persistent data store for said records, said persistent data store in communication with said server.

13. The system of claim 12, wherein said persistent data store comprises one of:
a relational database;
an object-oriented database; and
custom-formatted files.

14. The system of claim 12, wherein accesses to said persistent data store are mediated through a standard API.

15. The system of claim 2, further comprising at least one client.

16. The system of claim 15, wherein said client comprises:
a servlet component instantiated on a web server, said servlet component providing a link between said server and a web browser.

17. The system of claim 15, wherein said client comprises an intranet application.

18. The system of claim 15, said client including a user interface, wherein said user interface displays said threaded trails of communication.

19. The system of claim 18, said user interface comprising means for:
creating a new post;
viewing a list of posts and responses in order of creation;
searching posts and responses according to user-defined criteria;
viewing a list of all responses to a given post as a collapsible hierarchy;
opening and viewing an item;
creating a new response for any given post or response;
deleting a post/response item;
viewing detailed information related to a post/response item; and
creating a placeholder for a future item.

20. The system of claim 19, wherein a post/response item can only be deleted by creator of said item or a system administrator.

21. The system of claim 1, further comprising means for associating said threaded trail with any of a process and a process step.

22. A method of threading heterogeneous items of electronic communication into a post-response metaphor, comprising:
providing means for interfacing with a plurality of external communication systems of varying type; and
providing a server,
creating records on said server that uniquely identify and link communication items created by a plurality of users within any of said external communication systems; and
creating a threaded trail of collaborative communication according to said links.

23. The method of claim 22, wherein said means for interfacing with said external communication systems comprises a threading connector API (application programming interface), said method further comprising the step of;
building connectors to said external communication systems by means of said threading connector API.

24. The method of claim 23, wherein said connectors define methods for interacting with said external communication systems.

25. The method of claim 23, wherein said defined methods include:
creating a new item;
deleting an existing item;
viewing an item;
editing an item; and
creating a placeholder for a future item.

26. The method of claim 23, further comprising the steps of:
accepting a request for an action from within said system by a connector and:
initiating said requested action in one of said external systems.

27. The method of claim 23, said server comprising a threading server, said record including:
a unique ID;
title;
description;
type;
original post ID;
parent ID; and
item data.

28. The method of claim 27, wherein item data comprises a marker or string passed to a native external system for the purpose of interacting with the item.

29. The method of claim 28, further comprising the step of:
storing said items of communication within the external system from which they originate.

30. The method of claim 27, further comprising the step of:
registering said connectors on said threading server.

31. The method of claim 30, wherein registering a connector comprises the steps of providing:
name of a communication type to be registered;
a description of said type to be registered;
at least one class that implements said connector of said type to be registered through a client;
at least one image file to designate items of said type to be registered within a user interface of said client; and
optionally, network address of a server for said type to be registered.

32. The method of claim 27, further comprising the step of:
said threading server providing a listing of registered communication types.

33. The method of claim 23, further comprising the step of:
providing a persistent data store for said records, said persistent data store in communication with said server.

34. The method of claim 33, wherein said persistent data store comprises one of:
a relational database;
an object-oriented database; and
custom-formatted files.

35. The method of claim 33, further comprising the step of:
providing a standard API through which accesses to said persistent data store are mediated.

36. The method of claim 23, further comprising the step of providing at least one client.

37. The method of claim 36, wherein said client comprises:
a servlet component instantiated on a web server, said servlet component providing a link between said server and a web browser.

38. The method of claim 36, wherein said client comprises an intranet application.

39. The method of claim 36, said client including a user interface, said method further comprising the step of:
displaying said threaded trails of communication in said user interface.

40. The method of 39, further comprising any of the steps of:
creating a new post;
viewing a list of posts and responses in order of creation;
searching posts and responses according to user-defined criteria;
viewing a list of all responses to a given post as a collapsible hierarchy;
opening and viewing an item;
creating a new response for any given post or response;
deleting a post/response item;
viewing detailed information related to a post/response item; and
creating a placeholder.

41. The method of claim 40, wherein a post/response item can only be deleted by creator of said item or a system administrator.

42. The method of claim 22, further comprising means for associating said threaded trail with any of a process and a process step.

43. A graphical user interface for displaying and accessing heterogeneous items of electronic communication threaded into a post-response metaphor comprising:
a workspace;
an electronic form displayed within said workspace wherein said items of communication are presented in a threaded trail of collaborative communication;
means for creating and accessing items of communication by a user; and
means for creating placeholders for future items.

44. The user interface of claim 43, wherein said threaded trail comprises a root post, and a plurality of related posts arranged in a post-response metaphor, and wherein a response is associated with its parent post, so that posts and responses are displayed in a hierarchy, said root post forming the top level of the hierarchy.

45. The user interface of claim 44, wherein entries on said form comprise records representative of said items of communication, said items of communication externally created and stored.

46. The user interface of claim 45, wherein said means for creating and accessing said items comprises a plurality of interface elements, wherein activation of an interface element invokes a connector to an external communication system wherein an item is either created or modified.

47. The user interface of claim 46, wherein a connector comprises a class that defines methods for interacting with said external system.

48. The user interface of claim 47, wherein user requests are received by said connector and initiated on said external system.

49. The user interface of claim 46, wherein interacting with said external system includes any of:
creating a new post;
viewing a list of posts and responses in order of creation;
searching posts and responses according to user-defined criteria;
viewing a list of all responses to a given post as a collapsible hierarchy;
opening and viewing an item;
creating a new response for any given post or response;
deleting a post/response item;
viewing detailed information related to a post/response item; and
creating a placeholder for an item;
wherein operations are performed within context of a process or step.

50. The user interface of claim 46, wherein said means for creating a placeholder comprises means for creating a record for an item of communication in advance of creating said item, so that said record is displayed as a placeholder within said trail.

51. The user interface of claim 43, further comprising means for displaying a process and its component steps.

52. The user interface of claim 54, further comprising means for displaying said threaded trail in a context of an associated step of a process.
